(19) United States
(12) Patent Application Publication
(10) Pub. No.: US 2021/0143501 A1
(43) Pub. Date: May 13, 2021

(54) HYBRID BATTERIES AND BATTERY SYSTEMS

(71) Applicant: ENEVATE CORPORATION, Irvine, CA (US)

(72) Inventors: Benjamin Yong Park, Mission Viejo, CA (US); Shiang Jen Teng, Irvine, CA (US); Robert A. Rango, Irvine, CA (US); Jarvis Tou, Irvine, CA (US); Monika Chhorng, Tustin, CA (US)

(21) Appl. No.: 16/677,519

(22) Filed: Nov. 7, 2019

(51) Int. Cl. H01M 12/00; H01M 4/38; H01M 4/505; H01M 4/525; H01M 4/133

(52) U.S. Cl. CPC H01M 12/00; H01M 4/386; H01M 4/133; H01M 4/525; H01M 4/505

(57) ABSTRACT

Hybrid batteries and hybrid battery systems are provided. The hybrid battery systems described herein can include at least one first electrode comprising a first active material, at least one second electrode comprising a second active material, at least one first opposite electrode positioned between the first electrode and the second electrode, a plurality of separators, and an electrolyte. Each of the plurality of separators is positioned between the at least one first electrode and the at least one first opposite electrode and between the at least one second electrode and the at least one first opposite electrode. The hybrid battery systems can be lithium-ion hybrid battery systems.

### BACKGROUND

### Field

The present invention relates generally to hybrid batteries and battery systems. In particular, the present invention relates to hybrid batteries and hybrid battery systems including two or more different electrodes.

### Description of the Related Art

Hybrid batteries or hybrid battery systems seek to combine the advantages of different electro-chemical cell chemistries or different electrode active materials. Some hybrid battery systems combine a low voltage electro-chemical cell and a high voltage electro-chemical cell, such as a lower voltage lead-acid cell and a higher voltage lithium-ion cell to provide power to support both high and low power loads with a single battery. However, these cells can be expensive and complicated to manufacture because the different electro-chemical cells may require different manufacturing techniques and materials. Other hybrid battery systems may combine different active materials within a single electrode of an electro-chemical cell in order to improve power characteristics. Where these hybrid battery systems include multiple electrodes, each of the electrodes has the same electrical properties.

### SUMMARY

In some aspects, a hybrid battery is provided. The hybrid battery has at least one first electrode comprising a first active material, at least one second electrode comprising a second active material, at least one first opposite electrode positioned between the first electrode and the second electrode, a plurality of separators, and an electrolyte. Each of the plurality of separators is positioned between the at least one first electrode and the at least one first opposite electrode and between the at least one second electrode and the at least one first opposite electrode.

In some implementations, the at least one first electrode is a first anode and the at least one second electrode is a second anode. In some embodiments, the first active material comprises silicon. The second active material comprises graphite, hard carbon, titanate, or tin. The at least one first opposite electrode is a first cathode. In some embodiments, the first cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate. The hybrid battery may further includes a second opposite electrode, wherein the second opposite electrode is a second cathode. In some embodiments, the second cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

In some implementations, the at least one first electrode is a first cathode and the at least one second electrode is a second cathode. In some embodiments, the first active material and the second active material are different and are each independently selected from the group consisting of lithium cobalt oxide, lithium manganese oxide, lithium nickel cobalt manganese oxide, lithium nickel cobalt aluminum oxide, lithium nickel manganese spinel, and lithium iron phosphate. The at least one first opposite electrode may be an anode comprising silicon. In some embodiments, the anode is a silicon-dominant anode.

In some embodiments, the first active material is the same as the second active material. In some embodiments, the first active material and the second active material comprises silicon. In some embodiments, the at least one first electrode is a high-energy anode and the at least one second electrode is a high-power anode. The at least one first opposite electrode is a first cathode. The first cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

In some implementations, the at least one first electrode is a high-energy cathode and the at least one second electrode is a high-power cathode. In some embodiments, the high-energy cathode and the high-power cathode comprises the same cathode active material selected from the group consisting of lithium cobalt oxide, lithium manganese oxide, lithium nickel cobalt manganese oxide, lithium nickel cobalt aluminum oxide, lithium nickel manganese spinel, and lithium iron phosphate. In some embodiments, the at least one first opposite electrode is a first anode. In some embodiments, the first anode is a Si-based anode. The first anode can also be a Si-dominant anode. In some embodiments, the first anode has an excess capacity compared to the high-energy cathode and the high-power cathode.

In some implementations, the at least one first electrode and the at least one second electrode are the same, and each comprises a high-energy cathode active material layer and a high-power cathode active material layer disposed on each side of a first current collector. In some embodiments, each of the high-energy cathode active material layer and the high-power cathode active material layer comprises the same material selected from the group consisting of lithium cobalt oxide, lithium manganese oxide, lithium nickel cobalt manganese oxide, lithium nickel cobalt aluminum oxide, lithium nickel manganese spinel, and lithium iron phosphate. In some embodiments, the at least one first opposite electrode is an anode comprising a high-energy anode active material layer and a high-power anode active material layer disposed on each side of a second current collector. In some embodiments, the high-energy anode active material layer is paired with the high-energy cathode active material layer, and the high-power anode active material layer is paired with the high-power cathode active material layer. Alternatively, the at least one first opposite electrode is an anode comprising Si. The anode comprises the same anode active material layer on each side of a second current collection. In some embodiments, the anode active material layer has an excess capacity compared to the high-energy cathode active material layer and the high-power cathode active material layer.

### BRIEF DESCRIPTION OF THE DRAWINGS

FIG. 1 is a schematic illustration of an embodiment of hybrid battery system containing two different types of cells. The hybrid battery includes two types of alternating electrodes and an opposing electrode disposed between each of the alternating electrodes.

FIG. 2 is a schematic illustration of an embodiment of hybrid battery system formed from alternating anodes comprising different electrode active materials, with cathodes disposed between each alternating anodes.

FIG. 3 is a schematic illustration of an embodiment of hybrid battery system formed from alternating cathodes, with an anodes disposed between each alternating cathodes according to some implementations.

FIG. 4 is a schematic illustration of an embodiment of hybrid battery system formed from a combination of high-energy and high-power layers of electrodes according to some implementations.

FIG. 5 is a schematic illustration of an embodiment of hybrid battery system formed from alternating high-energy anodes and high-power anodes, with first opposite cathodes disposed between the alternating anodes according to some implementations.

FIG. 6 is a graph showing the capacity as a function of number of cycles for a hybrid battery system comprising alternating anodes comprising silicon and anodes comprising graphite according to some embodiments compared to a battery comprising silicon anodes.

FIG. 7 is a graph showing capacity retention as a function of number of cycles for a hybrid battery system comprising alternating anodes comprising silicon and anodes comprising graphite according to some embodiments compared to a battery comprising silicon anodes.

FIG. 8 is a graph showing capacity retention as a function of number of cycles for a hybrid battery system comprising alternating cathodes comprising lithium nickel cobalt aluminum (NCA) and cathodes comprising lithium cobalt oxide (LCO) according to some embodiments compared to a battery comprising LCO cathodes.

### DETAILED DESCRIPTION

Typical batteries and battery system, for example lithium-ion battery systems, comprise an electro-chemical cell or multiple electro-chemical cells that are electrically connected. A lithium-ion electro-chemical cell typically includes a separator and/or electrolyte between an anode and a cathode. In one class of batteries, the separator, cathode and anode materials are individually formed into sheets or films. Sheets of the cathode, separator and anode are subsequently stacked or rolled with the separator separating the cathode and anode (e.g., electrodes) to form the battery. A battery may comprise multiple anodes and cathodes that are stacked or rolled with a separator positioned between each anode/cathode pair. For the cathode, separator and anode to be rolled, each sheet must be sufficiently deformable or flexible to be rolled without failures, such as cracks, brakes, mechanical failures, etc. Typical electrodes include electro-chemically active material layers on an electrically conductive metal layer or current collector (e.g., aluminum or copper). Films can be rolled or cut into pieces which are then layered into a stack. The stack has alternating anodes and cathodes, with the separator between them. A battery may also comprise two or more electro-chemical cells that are electrically connected and which may also be stacked or rolled into a desired form.

A typical stacked cell battery design can include multiple pairs of anodes and cathodes stacked together. A stacked hybrid battery system design described in the present disclosure may have a substantially similar structure to a typical stacked cell battery design; however, instead of using only one type of anodes and one type of cathodes, two types of anodes and/or two types of cathodes can be used in a single stacked cell battery design. For example, in some embodiments, every other anode in the stack cell may be replaced with a different type of anode materials. In other embodiments, every other cathode in the stack cell may be replaced with a different type of cathode material.

In a hybrid battery design, at least two different cells can be combine to utilize the advantages of both cells. For example, cells that involve different chemistries may have different advantages. Combining different cells into a hybrid battery could also increase the packaging efficiency comparing to combining different type of batteries, and lower the cost at the same time. While it is also possible to mix active materials in an electrode, the materials are likely to interact with each other, which can make it harder to control the properties of the electrode.

A hybrid battery or hybrid battery system that combines at least two different types of cells is described. In general, the two different types of cells include high-energy cells and high-power cells. Such hybrid battery may include combining two different types of anodes with one type of cathodes, combining two different types of cathodes with one type of anodes, combining one type of anodes with one type of cathodes, or combining two types of anodes with two types of cathodes. Various combinations of electrodes can be used to create high-energy cells and low-energy cells.

The hybrid battery or hybrid battery system may include a first electrode, a second electrode, a first opposite electrode, a separator between the first electrode and the first opposite electrode, a separator between the second electrode and the first opposite electrode, and an electrolyte. A plurality of the first electrodes, a plurality of the second electrodes, and a plurality of the first opposite electrodes can form a cell stack with requisite separators in between opposite electrodes. The electrodes in the cell stack can be arranged in various ways. For example, assuming the first electrode is A and the second electrode is B, the cell stack arrangement (omitting the opposite electrodes) can include, but not limited to, ABABABAB, ABBAABBA, AAAABBBB, AABBAABB, etc. Furthermore, it is not necessary to have equal number of the first and the second electrodes. In some cases, there could be more first electrodes, and in other cases, there could be more second electrodes.

Optionally, the hybrid battery or hybrid battery system may further include a second opposite electrode. Thus, the hybrid battery or battery system would have two different types of anodes and two different types of cathodes.

A hybrid battery may have an alternating first and second electrodes arrangement in the cell stack. With reference to FIG. 1, the hybrid battery or battery system 100 includes a first electrode 112, a second electrode 114, a first opposite electrode 116 positioned between the first electrode 112 and the second electrode 114, and an electrolyte 110. The first electrode 112 is separated from the first opposite electrode 116 by a separator 118. The second electrode 114 is separated from the first opposite electrode 116 by another separator 118. The first electrode 112 and the second electrode 114 may be two different types of anodes, while the first opposite electrode 116 is a cathode. Alternatively, the first electrode 112 and the second electrode 114 may be two different types of cathodes, while the first opposite electrode 116 is an anode. Alternatively, the first electrode 112 and the second electrode 114 may be the same type of anodes or the same type of cathodes.

Each electrode comprises two active material layers disposed on each side of the current collector. The first electrode active material layer 112a and the first opposite electrode active material layer 116a, together with the separator 118a, are considered a first cell 120. The second electrode active material layer 114b and the first opposite electrode active material layer 116b, together with the separator 118b, are considered a second cell 130. The first electrode 112 and the second electrode 114 may each comprise a different active material (see e.g., FIGS. 2 and 3). Thus, the first cell 120 and the second cell 130 operate on different chemistries, and one cell may produce higher energy while the other cell may produce higher power. Alternatively, the first electrode 112 and the second electrode 114 may comprise the same active material. In this case, one of the first and the second electrodes may have thicker active material films, while the other have thinner active material films (see e.g., FIG. 5). The electrode that has thicker active material films may produce higher power while the electrode with thinner active material films produces higher energy. Alternatively, in the case where the first electrode 112 and the second electrode 114 comprise the same active material, different thickness active material film layers may be disposed on each side of the first and the second electrodes 112 and 114. Similarly, the first opposite electrode 116 would have different thickness active material films (116a and 116b) on each side of the current collector 122 (see e.g., FIG. 4).

The hybrid battery 100 includes a plurality of the first cells 120 and a plurality of the second cells 130. The first cells 120 and second cells 130 are connected in parallel to forms a cell stack. The hybrid battery or battery system 100 may include between 2 to 100 cells. For example, 2 or more, 3 or more, 4 or more, 5 or more, 6 or more, 7 or more, 9 or more, or 10 or more first cells, and 2 or more, 3 or more, 4 or more, 5 or more, 6 or more, 7 or more, 9 or more, 10 or more, 15 or more, 20 or more, 25 or more, 30 or more, 35 or more, 40 or more, 45 or more, 50 or more, 55 or more, or 60 or more cells, including any number of cells between 2 and 100 cells and any ranges in between. Preferably, the first cell 120 and the second cell 130 have voltages within about 1V of each other, within about 0.75V of each other, within about 0.5V of each other, within about 0.25V of each other, or within about 0.1V of each other. In some embodiments, the first cell 120 and the second cell 130 may have a substantially identical voltage. As a result, the two type of cells can have the same charge regime, and may be connected in parallel.

FIG. 1 depicts a hybrid battery that has an alternating first and second electrodes arrangement, it is not necessary to have such electrode arrangement. As discussed above, any arrangement within the cell stack will work.

Hybrid System with Mixed Chemistries

A hybrid battery may include electrodes with different active materials. This includes utilizing two different types of anodes, each made from a different active material, with one type of cathode. Alternatively, the hybrid battery may include two or more types of cathode, each made from a different active material, with one type of anode, or utilizing two types of anodes with two types of cathodes. It is preferable that the mixed electrodes of different chemistries have similar charge regime in the battery system.

As depicted in FIG. 2, the first electrodes and the second electrodes are both anodes, and the first opposite electrodes are cathodes. The hybrid battery system 200 comprises a first anode 212, a second anode 214, a cathode 216 between the first anode 212 and the second anode 214, and an electrolyte 210 in contact with the first anode 212, the second anode 214, and the cathode 216. The hybrid battery system 200 further comprises a separator 218 between each electrodes. For example, a separator 218a separates the first anode active material layer 212a and the cathode active material layer 216a, and a second separator 218b separates the cathode active material layer 216a and the second anode active material layer 214a. The first anode active material 212a and the cathode active material layer 216a, together with a separator 218a in between may be referred to as a first cell, and the second anode active material layer 214b and the cathode active material layer 216b together with a separator 218b in between, may be referred to as a second cell.

The first anode 212 may comprise a first active material, and the second anode 214 may comprise a second active material. The first active material may comprise silicon. For example, the first electrode active material may comprise a composite material, for example silicon composite materials and/or silicon-carbon composite materials. The first active material may comprise greater than about 50%, about 60% to about 95%, about 70% to about 95%, or about 75% to about 95% of silicon by weigh, thus the first anode 212 can be referred to as a silicon-dominant anode. In some embodiments, the silicon-dominant anode holds a very high energy density, such as greater than about 1000 mAh/g, greater than about 1500 mAh/g, or about 1000 to about 2000 mAh/g. The second active material may comprise graphite, hard carbon, titanate, or tin. For example, the second anode may be a graphite-dominant anode. In some cases, the second active material may be substantially free of silicon. Alternatively, the second active material may further comprise silicon at an amount of less than 50%.

The advantages of a silicon-dominant anode may include improved energy density, improved low temperature performance, improved charge and discharge rate capability (especially charge rate), and improved safety. The graphite-dominant anode may afford an increased cycle life, and may reduce costs. By mixing the silicon-dominant anodes with the graphite-dominant anodes in one hybrid battery system, the hybrid battery may have at least some advantages of both type of anodes.

As depicted in FIG. 3, the first electrodes and the second electrodes are both cathodes (e.g., the first cathodes 312 and the second cathode 314), while the first opposite electrodes are anodes 316. The hybrid battery system 300 comprises a first cathode 312, a second cathode 314, an anode 316 between the first anode 312 and the second anode 314, and an electrolyte 310 in contact with the first anode 312, the second anode 314, and the cathode 316. The hybrid battery system 300 further comprises a separator 318 between each electrodes. The first cathode 312 may comprise a first cathode active material, and the second cathode 314 may comprise a second active material. The first cathode active material layer 312a and the anode active material layer 316a together with a separation 318a in between may be referred to as a first cell 320, and the second cathode active material layer 314b and the anode active material layer 316b together with the separator 318b in between may be referred to as a second cell 330.

The anode active material may comprise silicon. Preferably the anode may be a Si-dominant anode as described above. The first cathode material and the second cathode material may include metal oxide cathode materials as described below. The first cathode material and the second cathode material may be independently selected from various types of NCM (e.g., NCM-111, NCM-523, NCM-622, NCM-811, etc.), lithium cobalt oxide (LCO), lithium nickel cobalt aluminum oxide (NCA), lithium manganese spinel (LMO), lithium iron phosphate (LFP), lithium nickel manganese spinel (LNMO), etc. In some implementations, the first cathode 312 may be a lithium cobalt oxide (LCO) cathode, and the second cathode 314 may be a lithium nickel cobalt aluminum (NCA) cathode.

A hybrid battery system 300 may have an improved cycle life as compared to a substantially similar battery system formed from cathodes including only a single kind of electrode active material, for example LCO. In some embodiments a hybrid battery system 300 may have a 1%, 5%, 10%, or greater improvement in capacity retention after 150 cycles as compared to substantially similar battery system formed from cathodes including only a single kind of electrode active material, for example LCO

Hybrid System with the Same Chemistry

A hybrid battery or battery system can also be created using one type of anode active material and one type of cathode active material. FIG. 4 depicts an example of hybrid battery or battery system 400 that combines high-power cells 420 and high-energy cells 430. For examples, both anodes and cathodes can be made by disposing a thicker active material layer on one side of the current collector 422 and a thinner active material on the other side, assuming the density of the active material is the same. The side of electrode with a thicker active material layer would serve as a high-energy electrode, while the side with a thinner active material layer would serve as a high-power electrode. The “high-energy electrode” is the electrode that can store and provide more energy than the “high-power electrode.” The “high-power electrode,” on the other hand, can provide more power than the “high-energy electrode” while discharging. The thicker active material layer would provide more capacity for storing the power during charging, and therefore can provide more energy while discharging. On the other hand, the thinner active material layer would allow the electrons to move to the current collector faster, thus provide higher power when needed during discharging.

Other physical properties of the electrode or active material layer can also be varied for making a high-power or a high-energy electrode. For example, compared to the second electrode, the first electrode having a higher active material loading (% of active material in the electrode), higher density, lower porosity, lower particle surface area, less conductive additives (the amount of conductive additives or the type of conductive additives), conductive additives with lower surface area, or higher mass loading (mg/cm²) would be considered a high-energy electrode. The second electrode would have a lower active material loading (% of active material in the electrode layer), lower density, higher porosity, higher particle surface area, more conductive additives (the amount of conductive additives or the type of conductive additives), conductive additives with higher surface area, or lower mass loading (mg/cm²) relative to the first electrode, and thus considered a high-power electrode.

With reference to FIG. 4, the hybrid battery 400 contains a plurality of anodes 412 and a plurality of cathode 416, and a separator 418 is disposed between each electrodes. The anode 412 has a high-power anode active material layer 412a on one side of the current collector 422 and a high-energy anode active material layer 412b on the other side. The cathode 416 also has a high-power cathode active material layer 416a on one side of the current collector 422 and a high-energy cathode active material layer 416b on the other side. In some implementations, the electrodes can be arranged so that the high-power anode active material 412a side is paired with the high-power cathode active material 416a side to form a first cell (i.e., a high-power cell 420), with a separator 418a in between. The high-energy anode active material 412b side is paired with the high-energy cathode active material 416b side with a separator 418b in between to form a second cell (i.e., a high-energy cell 430). The hybrid battery 400 further contains an electrolyte 410. The additional advantages of this embodiment include the need for only two electrode active materials to construct the hybrid battery, and only two types of electrodes (i.e., one type of anode and one type of cathode) need to be manufactured. The anodes are all high-power/high-energy combination anodes, and the cathodes are all high-power/high-energy combination cathodes.

Alternatively, the anodes 412 can have the same anode active material layers on each side of the current collector. The anode active material layer 412a or 412b can have an excess capacity compared to either the high-energy cathode active material layer 416b or the high-power cathode active material layer 416a. In this case, the hybrid battery design can be further simplified by having a symmetrical anode that can be paired with either the high-energy cathode active material layer 416b or the high-power cathode active material layer 416a.

FIG. 5 depicts another example of a hybrid battery or battery system 500 that combines high-power cells 520 and high-energy cells 530. The first electrode 512 may be a high-power electrode that has a high-power electrode layer 512a on each side of the current collector, the second electrode 514 may be a high-energy electrode that has a high-energy electrode layers 514b on each side of the current collector. The first opposite electrode 516 has an electrode layer 516b on each side, and is positioned in between the first electrode 512 and the second electrode 513. In some implementations, the first electrode 512 may be a high-power anode, the second electrode 514 may be a high-energy anode, and the first opposite electrode 516 is a cathode. Thus the high-power electrode layer 512a can be a high-power anode layer, the high-energy electrode layers 514b can be a high-energy anode layer, and the electrode layers 516a and 516b are cathode layers.

The high-power cell 520 is formed by pairing a high-power anode layer and a cathode layer with a separator 518a in between. The high-energy cell 530 is formed by pairing a high-energy anode layer and a cathode layer with a separator 518b in between. In this case, two types of anodes and one type of cathode are used. The two types of anodes can be made from the same active material. By making the anode active material layers thinner, a high-power anode can be created. Making the anode active material layers thicker, a high-energy anode can be created. Similarly, a high-energy electrode can also be made by having higher active material loading (% of active material in the electrode layer), higher density, lower porosity, lower particle surface area, less conductive additives (the amount of conductive additives or the type of conductive additives), conductive additives with lower surface area, or higher mass loading (mg/cm²) relative to a high-power electrode. Thus, a high-power electrode can also be made by having lower active material loading (% of active material in the electrode layer), lower density, higher porosity, higher particle surface area, more conductive additives (the amount of conductive additives or the type of conductive additives), conductive additives with higher surface area, or lower mass loading (mg/cm²) relative to a high-energy electrode.

Thus the hybrid battery or battery system can be formed by combining high-energy electrode and high-power electrode made from the same active material (i.e., with the same electrode chemistry) with one type of opposite electrode. The electrodes are arranged so the cell stack includes alternating anodes and cathodes. Although FIG. 5 shows the arrangement where every other anodes are high-energy anodes while the rest of the anodes are high-power anodes, the arrangement of anodes may be different. For example, all the high-energy anodes can be on one side of the cell stack while the high-power anodes are on the other side. Alternatively, a few high-energy anodes may be arranged into a group and a few high-power anodes may be arranged into another group, and the groups may alternate or arranged in any way in the cell stack. The advantage include the simplicity of only two electrode active materials are needed (e.g., one for anodes and one for cathodes).

Furthermore, the same type of hybrid battery can also be formed by combining high-energy cathodes and high-power cathodes with one type of anodes, instead of combining high-energy anodes and high-power anodes with one type of cathodes as described above. The arrangements of the electrodes are the same as above, except the cathodes and anodes are switched. For example, with reference to FIG. 5, in some implementations, the first electrode 512 may be a high-power cathode, the second electrode 514 may be a high-energy cathode, and the first opposite electrode 516 is an anode. Thus the high-power electrode layer 512a can be a high-power cathode layer, the high-energy electrode layers 514b can be a high-energy cathode layer, and the electrode layers 516a and 516b are anode layers. In some embodiments, the anodes can have excess capacity compared to the capacity of the cathodes.

Although FIGS. 2, 4, and 5 depict hybrid batteries that have an alternating first and second electrodes arrangement, it is not necessary to have such electrode arrangement. As discussed above, any arrangement within the cell stacks will work.

### Anode Materials

Silicon (Si) may be used as the active material for the anode. Thus, the anode for the energy storage device include silicon-based anode. Several types of silicon materials, e.g., silicon nanopowders, silicon nanofibers, porous silicon, and ball-milled silicon, are viable candidates as active materials for the anode. Alternatively, as described in U.S. patent application Ser. No. 13/008,800 and 13/601,976, entitled “Composite Materials for Electrochemical Storage” and “Silicon Particles for Battery Electrodes,” a Si-based anode can also contain a composite material film that includes Si particles distributed in a carbon phase. The Si-based anode can include one or more types of carbon phases. At least one of these carbon phases is a substantially continuous phase that extends across the entire film and holds the composite material film together. The Si particles are distributed throughout the composite material film.

The composite material film may be formed by pyrolyzing a mixture comprising a precursor (such as a polymer or a polymer precursor) and Si particles. The mixture can optionally further contain graphite particles. Pyrolyzation of the precursor results in one or more type of carbon phases. The mixture may be disposed on a current collector and pyrolyzed to form the composite material film. The composite material film can also be formed first before adhering it to the current collector. In some implementations, the composite material film can have a self-supporting monolithic structure, and therefore is a self-supporting composite material film.

The amount of carbon obtained from the precursor can be from about 2% to about 50%, from about 2% to about 40%, from about 2% to about 30%, from about 2% to about 25%, or from about 2% to about 20% by weight of the composite material. The carbon from the precursor can be hard carbon. Hard carbon can be a carbon that does not convert into graphite even with heating in excess of 2800 degrees Celsius. Precursors that melt or flow during pyrolysis convert into soft carbons and/or graphite with sufficient temperature and/or pressure. The hard carbon phase can be a matrix phase in the composite material. The hard carbon can also be embedded in the pores of the additives including silicon. The hard carbon may react with some of the additives to create some materials at interfaces. For example, there may be a silicon carbide layer between silicon particles and the hard carbon. Possible hard carbon precursors can include polyimide (or a polyimide precursor), phenolic resins, epoxy resins, and other polymers that have a very high melting point or are cross-linked.

The amount of Si particles in the composite material may be between greater than 0% and about 90% by weight, between about 20% and about 80%, between about 30% and about 80%, or between about 40% and about 80%. In some implementations, the amount of Si particles in the composite material may be between about 50% and about 90% by weight, between about 50% and about 80%, or between about 50% and about 70%, and such anode is considered as a Si-dominant anode. The amount of one or more types of carbon phases in the composite material may be between greater than 0% and about 90% by weight or between about 1% and about 70% by weight. The pyrolyzed/carbonized polymer can form a substantially continuous conductive carbon phase in the entire electrode as opposed to particulate carbon suspended in a non-conductive binder in one class of conventional lithium-ion battery electrodes.

The largest dimension of the silicon particles can be less than about 40 μm, less than about 1 μm, between about 10 nm and about 40 μm, between about 10 nm and about 1 μm, less than about 500 nm, less than about 100 nm, and about 100 nm. All, substantially all, or at least some of the silicon particles may comprise the largest dimension described above. For example, an average or median largest dimension of the silicon particles can be less than about 40 μm, less than about 1 μm, between about 10 nm and about 40 μm, between about 10 nm and about 1 μm, less than about 500 nm, less than about 100 nm, and about 100 nm. Furthermore, the silicon particles may or may not be pure silicon. For example, the silicon particles may be substantially silicon or may be a silicon alloy. The silicon alloy includes silicon as the primary constituent along with one or more other elements.

Micron-sized silicon particles can provide good volumetric and gravimetric energy density combined with good cycle life. In certain implementations, to obtain the benefits of both micron-sized silicon particles (e.g., high energy density) and nanometer-sized silicon particles (e.g., good cycle behavior), silicon particles can have an average particle size in the micron range and a surface including nanometer-sized features. The silicon particles have an average particle size (e.g., average diameter or average largest dimension) between about 0.1 μm and about 30 μm or between about 0.1 μm and all values up to about 30 μm. For example, the silicon particles can have an average particle size between about 0.5 μm and about 25 μm, between about 0.5 μm and about 20 μm, between about 0.5 μm and about 15 μm, between about 0.5 μm and about 10 μm, between about 0.5 μm and about 5 μm, between about 0.5 μm and about 2 μm, between about 1 μm and about 20 μm, between about 1 μm and about 15 μm, between about 1 μm and about 10 μm, between about 5 μm and about 20 μm, etc. Thus, the average particle size can be any value between about 0.1 μm and about 30 μm, e.g., 0.1 μm, 0.5 μm, 1 μm, 5 μm, 10 μm, 15 μm, 20 μm, 25 μm, and 30 μm.

In certain embodiments, the silicon particles are at least partially crystalline, substantially crystalline, and/or fully crystalline. Furthermore, the silicon particles may or may not be pure silicon. For example, the silicon particles may be substantially silicon or may be a silicon alloy. In one embodiment, the silicon alloy includes silicon as the primary constituent along with one or more other elements, such as Sn, Cu, Al, or Ni. In some embodiments, the silicon particles may be substantially pure silicon. In some embodiments the silicon particles may be from about 90% pure silicon to about 100% pure silicon.

The silicon particles may have a naturally occurring native oxide layer thereon. This native oxide layer is present on the surface of the silicon particles and may result from a reaction between the silicon particle and oxygen present in the ambient environment. In some embodiments the native oxide layer may comprise at least one of silicon monoxide (SiO), silicon dioxide (SiO₂), and silicon oxide (SiOₓ).

The carbonized precursor or resin may contact the surface of the silicon particles. In certain embodiments, the carbonized precursor in contact with the silicon particle surface may be one or more types of carbon phases resulting from pyrolysis of a precursor, such as a polymer precursor. The one or more types of carbon phases of the carbonized precursor in contact with the silicon particle surface may react with the silicon particles during pyrolysis to thereby form silicon carbide on the silicon particle surface. In other embodiments, the silicon carbide may form from the reaction between the silicon particles and the gases produced from the pyrolysis of precursor. Therefore, in some embodiments, the silicon particles in the electrode active material may have surface layers that include carbon, silicon carbide, silicon oxide and/or a mixture of carbon, oxide and silicon carbide.

In some embodiments, a first portion of the surface layer may comprise silicon carbide while a second portion may comprise a mixture of silicon carbide and carbon or silicon oxide. In some other embodiments, the carbonized precursor in contact with the silicon particle surface may not fully convert the native silicon oxide layer to silicon carbide, and the resultant surface layer may comprise carbon, silicon carbide, and one or more silicon oxides, such as SiO, SiO₂, and SiOₓ.

Optionally, conductive particles that may also be electrochemically active are added to the mixture. Such particles can enable both a more electronically conductive composite as well as a more mechanically deformable composite capable of absorbing the large volumetric change incurred during lithiation and de-lithiation. A largest dimension of the conductive particles is between about 10 nanometers and about 100 microns. All, substantially all, or at least some of the conductive particles may comprise the largest dimension described herein. In some implementations, an average or median largest dimension of the conductive particles is between about 10 nm and about 100 microns. The mixture may include greater than 0% and up to about 80% by weight conductive particles. The composite material may include about 45% to about 80% by weight conductive particles. The conductive particles can be conductive carbon including carbon blacks, carbon fibers, carbon nanofibers, carbon nanotubes, graphite, graphene, etc. Many carbons that are considered as conductive additives that are not electrochemically active become active once pyrolyzed in a polymer matrix. Alternatively, the conductive particles can be metals or alloys, such as copper, nickel, or stainless steel.

For example, graphite particles can be added to the mixture. Graphite can be an electrochemically active material in the battery as well as an elastic deformable material that can respond to volume change of the silicon particles. Graphite is the preferred active anode material for certain classes of lithium-ion batteries currently on the market because it has a low irreversible capacity. Additionally, graphite is softer than hard carbon and can better absorb the volume expansion of silicon additives. Preferably, a largest dimension of the graphite particles is between about 0.5 microns and about 100 microns. All, substantially all, or at least some of the graphite particles may comprise the largest dimension described herein. In some implementations, an average or median largest dimension of the graphite particles is between about 0.5 microns and about 100 microns. The mixture may include about 2% to about 50% by weight of graphite particles. The composite material may include about 40% to about 75% by weight graphite particles.

The composite material may also be formed into a powder. For example, the composite material can be ground into a powder. The composite material powder can be used as an active material for an electrode. For example, the composite material powder can be deposited on a current collector in a manner similar to making a conventional electrode structure, as known in the industry.

In some embodiments, the full capacity of the composite material may not be utilized during use of the battery to improve battery life (e.g., number charge and discharge cycles before the battery fails or the performance of the battery decreases below a usability level). For example, a composite material with about 70% by weight silicon particles, about 20% by weight carbon from a precursor, and about 10% by weight graphite may have a maximum gravimetric capacity of about 2000 mAh/g, while the composite material may only be used up to a gravimetric capacity of about 550 to about 850 mAh/g. Although, the maximum gravimetric capacity of the composite material may not be utilized, using the composite material at a lower capacity can still achieve a higher capacity than certain lithium ion batteries. In certain embodiments, the composite material is used or only used at a gravimetric capacity below about 70% of the composite material's maximum gravimetric capacity. For example, the composite material is not used at a gravimetric capacity above about 70% of the composite material's maximum gravimetric capacity. In further embodiments, the composite material is used or only used at a gravimetric capacity below about 50% of the composite material's maximum gravimetric capacity or below about 30% of the composite material's maximum gravimetric capacity.

### Cathode Materials

The cathode for the hybrid battery may include metal oxide cathode materials, such as Lithium Cobalt Oxide (LiCoO₂) (LCO), lithium (Li)-rich oxides/layer oxides, nickel (Ni)-rich oxide/layered oxides, high-voltage spinel oxides, and high-voltage polyanionic compounds. Ni-rich oxides/layered oxides may include lithium nickel cobalt manganese oxide (LiNiCoMnO₂, “NCM”) and lithium nickel cobalt aluminum oxide (LiNiCoAlO₂, “NCA”), LiNi₁₋ₓMₓO₂ and LiNi₁₊ₓM₁₋ₓO₂ (where M=Co, Mn or Al). Examples of a NCM material include LiNi_{0.6}Co_{0.2}Mn_{0.2}O₂ (NCM-622), NCM-111, NC-433, NCM-523, NCM-811, and NCM-9 0.5 0.5. Li-rich oxides/layered oxides may include Li_{y}Ni₁₊ₓM₁₋ₓO₂ (where y>1, and M=Co, Mn or Ni), xLi₂MnO₃·(1−x)LiNiₐCo_{b}Mn_{c}O₂, and xLi₂Mn₃O₂·(1−x)LiNiₐCo_{b}Mn_{c}O₂. High-voltage spinel oxides may include lithium manganese spinel (LiMn₂O₄, “LMO”) or lithium nickel manganese spinel (LiNi_{0.5}Mn_{1.5}O₄, “LNMO”). High-voltage polyanionic compounds may include phosphates, sulfates, silicates, titanate, etc. One example of polyanionic compound may be lithium iron phosphase (LiFePO₄, “LFP”).

### Electrolyte System

An electrolyte for a Li-ion battery can include at least a solvent and a Li ion source, such as a Li-containing salt. The composition of the electrolyte may be selected to provide a Li-ion battery with improved performance. For example, the electrolyte may further contain one or more electrolyte additive(s), and/or additional co-solvent(s).

As disclosed herein, the electrolyte for a Li-ion battery may include more than one solvent. For example, the electrolyte includes co-solvents selected from a cyclic carbonate and a linear carbonate. In some implementations, the cyclic carbonate is a fluorine containing cyclic carbonate. Examples of the cyclic carbonate include fluoroethylene carbonate (FEC), di-fluoroethylene carbonate (DiFEC), trifluoropropylene carbonate (TFPC), ethylene carbonate (EC), vinyl carbonate (VC), and propylene carbonate (PC), 4-fluoromethyl-5-methyl-1,3-dioxolan-2-one (F-t-BC), 3,3-difluoropropylene carbonate (DFPC), 3,3,4,4,5,5,6,6,6-Nonafluorohexyl-1-ene carbonate, etc. Examples of the linear carbonate include ethyl methyl carbonate (EMC), dimethyl carbonate (DMC), and diethyl carbonate (DEC), and some partially or fully fluorinated ones. In some implementations, the electrolyte may further contain other co-solvent(s), such as methyl acetate (MA), ethyl acetate (EA), methyl propanoate, and gamma butyrolactone (GBL). The cyclic carbonates may be beneficial for SEI layer formations, while the linear carbonates may be helpful for dissolving Li-containing salt and for Li-ion transport.

One of the co-solvents may include a fluorine-containing compound, such as a fluorine-containing cyclic carbonate, a fluorine-containing linear carbonate, and/or a fluoroether. Examples of fluorine-containing compound may include FEC, DiFEC, TFPC,1,1,2,2-tetrafluoroethyl 2,2,3,3-tetrafluoropropyl ether), and other partially or fully fluorinated linear or cyclic carbonates and ethers, etc. In some embodiments, the electrolyte contains FEC. In some embodiments, the electrolyte contains both EMC and FEC. In some embodiments, the electrolyte is free or substantially free of non-fluorine-containing cyclic carbonates, such as EC, VC, and PC.

As used herein, a co-solvent of an electrolyte has a concentration of at least about 10% by volume (vol %). In some embodiments, a co-solvent of the electrolyte may be about 20 vol %, about 40 vol %, about 60 vol %, or about 80 vol %, or about 90 vol % of the electrolyte. In some embodiments, a co-solvent may have a concentration from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, or from about 30 vol % to about 50 vol %.

In some implementations, the electrolyte may further include one or more additives. As used herein, an additive of the electrolyte refers to a component that makes up less than 10% by weight (wt %) of the electrolyte. In some embodiments, the amount of each additive in the electrolyte may be from about 0.2 wt % to about 1 wt %, 0.1 wt % to about 2 wt %, 0.2 wt % to about 9 wt %, from about 0.5 wt % to about 9 wt %, from about 1 wt % to about 9 wt %, from about 1 wt % to about 8 wt %, from about 1 wt % to about 8 wt %, from about 1 wt % to about 7 wt %, from about 1 wt % to about 6 wt %, from about 1 wt % to about 5 wt %, from about 2 wt % to about 5 wt %, or any value in between. For example, the total amount of the additive(s) may be from about 1 wt % to about 9 wt %, from about 1 wt % to about 8 wt %, from about 1 wt % to about 7 wt %, from about 2 wt % to about 7 wt %, or any value in between.

In some embodiments, the first electrode may further include binders and/or other electro-chemically active materials in addition to the silicon particles. For example, the silicon particles described herein can be used as the silicon particles in the electrodes described herein. In another example, the first electrode can have an electro-chemically active material layer on a current collector, and the electro-chemically active material layer includes the silicon particles. The electro-chemically active material may also include one or more types of carbon.

Furthermore, not utilizing the full capacity of the first electrode comprising a Silicon composite material during discharge may improve the life of the hybrid battery (e.g., the number charge and discharge cycles before the battery fails or the performance of the battery decreases below a usability level). For example, a composite material with about 70% by weight silicon particles, about 20% by weight carbon from a precursor, and about 10% by weight graphite may have a maximum gravimetric capacity of about 2000 to 3000 mAh/g, while the composite material may only be used up to a gravimetric capacity of about 550 to about 1600 mAh/g. In certain embodiments, the composite material in some of the electrodes is used or only used at a gravimetric capacity below about 80% or below about 70% of the composite material's maximum gravimetric capacity. For example, the composite material is not used at a gravimetric capacity above about 70% or about 80% of the composite material's maximum gravimetric capacity. In further embodiments, the composite material is used or only used at a gravimetric capacity below about 50% of the composite material's maximum gravimetric capacity or below about 30% of the composite material's maximum gravimetric capacity. In some embodiments, the composite material is used at a gravimetric capacity of about 50% to about 80% of the composite material's maximum gravimetric capacity..

In some embodiments, the second electrode, or second anode 214, is different from the first anode 212. In some embodiments the second anode 214 may comprise carbon, for example in the form of graphite. In some embodiments the second electrode may comprise graphene, chopped or milled carbon fiber, carbon nanofibers, carbon nanotubes, activated carbon, carbide derived carbon, and/or other carbons. In some embodiments, the first anode 212 may be a Si-dominant electrode, while the second anode 214 may comprises less than about 50%, less than about 40%, or less than about 30% by weight of silicon.

In some embodiments, the first opposite electrode may be a cathode 216, which may comprise an electrode active material comprising lithium cobalt oxide (LCO). In some embodiments the first opposite cathode 216 may comprise an electrode active material comprising lithium nickel cobalt aluminum (NCA). In some embodiments, the cathode active material may comprise NCM (111, 532, 433, 622, 811, etc.), lithium manganese spinel (LMO), and lithium iron phosphate (LFP).

In some embodiments a hybrid battery system 200 may have an improvement in initial 0.5 C rate capacity over a substantially similar battery system formed from anodes including only a single type of electrode active material. For example, in some embodiments a hybrid battery system as described herein may have a greater than about 1%, greater than about 2%, greater than about 3%, greater than about 4%, greater than about 5%, greater than about 6%, greater than about 7%, or greater than about 10% increase in 0.5 C rate capacity as compared to a substantially similar battery system formed from anodes including only a single type of electrode active material, for example anodes formed from silicon.

In some embodiments, the full capacity of some of the first cell 220 may not be utilized during use. In some embodiments a first electro-chemical cell 220 may have an excess capacity of about 1% to about 10%, about 3% to about 8%, about 5% to about 7%, about 1%, about 5%, about 10%, or more. In some embodiments a first cell 220 may be able to charge at a much faster rate than a second cell 230. For example, a first electro-chemical cell 240 may be able to charge about 25% faster, about 50% faster, about 100% faster, about 150% faster, about 200% faster, or more. In some embodiments a first cell 220 may be able to charge at a faster rate than a second cell 230 at low operating temperatures, for example temperatures below about 0° C., below about −10° C., below about −30° C., or below about −40° C.

In some embodiments a first cell 220 may be able to charge about 25% faster, about 50% faster, about 100% faster, about 150% faster, about 200% faster, or more than a second cell 230 at operating temperatures below about 0° C. In some embodiments a first cell 220 may be able to charge about 25% faster, about 50% faster, about 100% faster, about 150% faster, about 200% faster, or more than a second electro-chemical cell 220 at operating temperatures below about −10° C. In some embodiments a first electro-chemical cell 240 may be able to charge about 25% faster, about 50% faster, about 100% faster, about 150% faster, about 200% faster, or more than a second cell 230 at operating temperatures below about −20° C. In some embodiments a first electro-chemical cell 220 may be able to charge about 25% faster, about 50% faster, about 100% faster, about 150% faster, about 200% faster, or more than a second cell 230 at operating temperatures below about −30° C. In some embodiments a first electro-chemical cell 220 may be able to charge about 25% faster, about 50% faster, about 100% faster, about 150% faster, about 200% faster, or more at operating temperatures below about −40° C., or lower than a second cell 230.

In some embodiments a hybrid battery system 200 may have an improved energy density, improved low temperature performance, improved rate capability, and improved safety as compared to a substantially similar battery system formed from anodes including only a single type of electrode active material. In some embodiments a hybrid battery system 200 may have a reduced cost compared to a substantially similar battery system formed from anodes including only a single type of anode active material, such as silicon. In some embodiments a hybrid battery system 100 may have an increased life cycle as compared to a substantially similar battery system formed from anodes including only a single type of electrode active material, such as silicon.

### Integration

In some embodiments a hybrid battery system as described herein may be used to provide power to, for example, an unmanned aerial vehicle (UAV) or drone. Typical UAV's have a variety of uses, including observational and military applications, as well as being used to deliver packages and other goods. For some UAV designs, a high rate of discharge of a battery is required to achieve take off, but a lower discharge rate may be utilized for cruising. In these UAV systems, a hybrid battery system as described herein and according to some embodiments including one or more first cells and one or more second, different cells may be utilized. In some embodiments, the one or more first cells may be high-energy cells, capable of storing more energy but discharging at a comparatively lower rate, while the one or more second cells may be high-power cells, capable of discharging at a comparatively higher rate. The high-power cells can be utilized during the take-off portion of the flight, while the high-energy cells can be utilized for cruising. For example, silicon-dominant anodes can be used in the high-energy cells, and the cells that don't use silicon-dominant anodes can be the high-discharge-power cell. One example of the non-silicon-dominant anode is a graphite anode.

According to some embodiments, the a UAV comprising a hybrid battery system as described herein may be able to achieve a longer flight time and longer range as compared to a similar UAV using a battery system that does not include alternating anodes.

Similarly, a hybrid battery can also be used for automobiles. The high-energy cells would provide energy storage for an extended range, while the high-power cells would be able to provide fast acceleration for a short period of time (e.g., useful for merging onto the freeway).

### EXAMPLES

The below examples describe electro-chemical cells which may form the hybrid battery systems described herein, in addition to example hybrid battery systems according to some embodiments.

An example hybrid battery system formed from two types of anodes and one type of cathodes as described herein and according to some embodiments was manufactured and tested for discharge capacity and capacity retention over a number of cycles. The sample hybrid battery system was formed from a plurality of first anodes including an anode active material comprising silicon and a plurality of second anodes including an anode active material comprising graphite as described herein with respect to FIG. 2. The first anode is a silicon-dominant anode comprising 80% silicon, 15% glassy carbon network, and 5% conductive carbon. The second anode is a graphite-based anode comprising 96% graphite and 4% PVdF binder. The cathodes included a cathode active material comprising LCO. The cathode was prepared by mixing LCO with 1% super P, and 2% PVdF binder. The electrolyte used was 1.2M LiPF6 in carbonate-based electrolyte. A standard battery system formed from only silicon anodes and LCO cathodes was also tested.

The cells were cycled initially at 22° C. over 3.30-4.30V range with a 0.96 C current four times to complete the formation process. The pouch cells were degassed and resealed to remove gases developed during the formation process. The cycle test was performed over 3.3-4.3V range with a 0.5 C constant current, and a 0.5 C current charging followed by 4.3V of voltage charging and a 0.2 C currently discharging over a 2.75-4.30V range every 50 cycles starting with the first cycle. As can be seen from FIG. 6, the hybrid battery system showed a 5.5% improvement in initial 0.5 C discharge capacity as comparted to the standard battery system. The hybrid battery system was able to maintain this relative improvement for 200 cycles.

Similarly, as illustrated in FIG. 7, the hybrid battery system showed an 8% improvement in cell discharge rate capability over the standard battery system. This improved cell discharge rate capability was observed with the hybrid battery system discharging at a 0.5 C rate, while the standard battery system was discharging at only a 0.2 C rate.

An example hybrid battery system formed from two types of alternating cathodes and one type of anodes as described herein and according to some embodiments was also manufactured and tested for capacity retention over a number of cycles. The sample hybrid battery system was formed from a plurality of first cathodes including a cathode active material comprising NCA and a plurality of second cathodes including a cathode active material comprising LCO as described herein with respect to FIG. 3. The anodes is a Si-dominant anode. A standard battery system formed from only LCO cathodes and silicon anodes was also tested (e.g., silicon-LCO system). The NCA cathodes were prepared by mixing NCA with 2.5% PVdF binder, and 2.5% conductive carbon. FIG. 8 shows that the hybrid battery system had a 6% improvement over the standard battery system in capacity retention over the silicon-LCO system at 200 cycles.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

What is claimed is:

1. A hybrid battery comprising:
at least one first electrode comprising a first active material;
at least one second electrode comprising a second active material;
at least one first opposite electrode positioned between the first electrode and the second electrode;
a plurality of separator, each positioned between the at least one first electrode and the at least one first opposite electrode and between the at least one second electrode and the at least one first opposite electrode; and
an electrolyte.

2. The hybrid battery of claim 1, wherein the at least one first electrode is a first anode and the at least one second electrode is a second anode.

3. The hybrid battery of claim 2, wherein the first active material comprises silicon.

4. The hybrid battery of claim 3, wherein the first anode is a Si-dominant anode.

5. The hybrid battery of claim 3, wherein second active material comprises graphite, hard carbon, titanate, or tin.

6. The hybrid battery of claim 2, wherein the at least one first opposite electrode is a first cathode.

7. The hybrid battery of claim 6, wherein the first cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

8. The hybrid battery of claim 6, further comprising a second opposite electrode, wherein the second opposite electrode is a second cathode.

9. The hybrid battery of claim 8, wherein the second cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

10. The hybrid battery of claim 1, wherein the at least one first electrode is a first cathode and the at least one second electrode is a second cathode.

11. The hybrid battery of claim 10, wherein the first active material and the second active material are different and are each independently selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

12. The hybrid battery of claim 10, wherein the first active material comprises lithium cobalt oxide and the second active material comprises lithium nickel cobalt aluminum oxide.

13. The hybrid battery of claim 10, wherein the at least one first opposite electrode is an anode comprising silicon.

14. The hybrid battery of claim 13, wherein the anode is a silicon-dominant anode.

15. The hybrid battery of claim 1, wherein the first active material is the same as the second active material.

16. The hybrid battery of claim 15, wherein the first active material and the second active material comprises silicon.

17. The hybrid battery of claim 15, wherein the at least one first electrode is a high-energy anode and the at least one second electrode is a high-power anode.

18. The hybrid battery of claim 17, wherein the high-energy anode is a Si-dominant anode.

19. The hybrid battery of claim 17, wherein the at least one first opposite electrode is a first cathode.

20. The hybrid battery of claim 19, wherein the first cathode is selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

21. The hybrid battery of claim 15, wherein the at least one first electrode is a high-energy cathode and the at least one second electrode is a high-power cathode.

22. The hybrid battery of claim 21, wherein the high-energy cathode and the high-power cathode comprises the same cathode active material selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

23. The hybrid battery of claim 21, wherein the at least one first opposite electrode is a first anode.

24. The hybrid battery of claim 23, wherein the first anode is a Si-based anode.

25. The hybrid battery of claim 24, wherein the first anode is a Si-dominant anode.

26. The hybrid battery of claim 23, wherein the first anode has an excess capacity compared to the high-energy cathode and the high-power cathode.

27. The hybrid battery of claim 15, wherein the at least one first electrode and the at least one second electrode are the same, and each comprises a high-energy cathode active material layer and a high-power cathode active material layer disposed on each side of a first current collector.

28. The hybrid battery of claim 27, wherein each of the high-energy cathode active material layer and the high-power cathode active material layer comprises the same material selected from the group consisting of lithium cobalt oxide, lithium manganese oxide, lithium nickel cobalt manganese oxide, lithium nickel cobalt aluminum oxide, lithium nickel manganese spinel, and lithium iron phosphate.

29. The hybrid battery of claim 27, wherein the at least one first opposite electrode is an anode comprising a high-energy anode active material layer and a high-power anode active material layer disposed on each side of a second current collector.

30. The hybrid battery of claim 29, wherein each of the high-energy anode active material layer and the high-power anode active material layer comprises Si.

31. The hybrid battery of claim 29, wherein the high-energy anode active material layer is paired with the high-energy cathode active material layer, and the high-power anode active material layer is paired with the high-power cathode active material layer.

32. The hybrid battery of claim 27, wherein the at least one first opposite electrode is an anode comprising Si.

33. The hybrid battery of claim 32, wherein the anode comprises the same anode active material layer on each side of a second current collection.

34. The hybrid battery of claim 33, wherein the anode active material layer has an excess capacity compared to the high-energy cathode active material layer and the high-power cathode active material layer.
